(19) United States
(12) Patent Application Publication
(10) Pub. No.: US 2009/0267902 A1
(43) Pub. Date: Oct. 29, 2009

(54) Touch Panel

(75) Inventors: Mototoshi Nambu, Toyama (JP); Toshiyuki Wakabayashi, Toyama (JP); Shinya Iwawaki, Toyama (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: SMK CORPORATION, Tokyo (JP)

(21) Appl. No.: 11/992,324

(22) PCT Filed: Apr. 28, 2006
(86) PCT No.: PCT/JP2006/309024

§ 371 Date: Mar. 20, 2008

(30) Foreign Application Priority Data
Sep. 21, 2005 (JP) 2005-273709

(51) Int. Cl. G06F 3/041

(52) U.S. Cl. 345/173

(57) ABSTRACT

There is provided a touch panel which has a simple configuration and which can be accurately and reliably operated.

It includes a panel 12 constituting a display screen and an elongated piezoelectric element 16 disposed and secured along each of at least two edges of the panel 12 crossing each other. It includes a pressed position calculating circuit 20 for calculating a position in the panel 12 which has been pressed based on output from the piezoelectric elements 16. It includes a boosting circuit 30 serving as piezoelectric element driving means for applying a voltage to the piezoelectric elements 16 to vibrate them when the pressed position in the panel 12 is calculated by the piezoelectric elements 16 and the pressed position detecting circuit 20.

### TECHNICAL FIELD

The present invention relates to touch panels provided on displays or operating units of various electronic apparatus and used as input devices.

### BACKGROUND ART

Electronic apparatus having a touch panel function on a surface of a display have been widely used. Resistive film type touch panels have been available as one of touch panel structures. Such a touch panel is provided by forming an ITO (indium oxide) film having a predetermined pattern on a surface of a touch panel glass, connecting electrodes to an end of the ITO film, and covering peripheral parts with an overcoat. Dot spacers are provided between two panels or top and bottom panels having an ITO film deposited thereon. The ITO films on the top and bottom panels contact each other when pressed, and the position of the press on the panel is detected from the value of a resistance generated at that time.

The position of a press on a touch panel of this type is detected from the value of a resistance generated when the ITO films on the top and bottom panels contact each other. The touch panel therefore has a complicated structure, and problems have occurred in the structure and during the assembly of the same in that position detection is disabled because of damages made during assembly and foreign substances deposited between the ITO films.

Other touch panel structures include optical touch panels. A plurality of infrared LEDs is provided in each of the transverse and longitudinal direction of such a panel, and a plurality of photo-transistors is provided opposite to them. Thus, the position of an input on the panel is detected when an optical path is interrupted by a finger or the like.

However, an optical touch panel has had a structural problem in that even when an operator stops a pressing operation immediately before touching the panel because a touch on the panel cannot be detected, an input is still accepted as long as an optical path is interrupted. There is another problem in that the position of a press cannot be accurately identified when light is interrupted obliquely with the finger or the like.

As disclosed in Patent Documents 1 to 3, there is a touch panel including force sensors or piezoelectric elements disposed at four corners of the panel for detecting forces generated by a pressing operation, in which forces applied to the panel at the time of a pressing operation can be detected, and the input position on the panel can be calculated based on the balance of forces indicated by detection outputs from the force sensors at the four corners.

Patent Document 1: WO96/38833

Patent Document 2: WO2002/084580

Patent Document 3: JP-A-62-58322

### DISCLOSURE OF THE INVENTION

### Problem that the Invention is to Solve

In any of the methods employed in the above-described techniques in the related art, a complicated structure is required to allow a mechanism for detecting the position of an input on a panel or the like to detect the input position accurately, and a position cannot be detected easily and accurately. Further, it is difficult for an operator to know whether an input signal has been transmitted from a panel as a result of a pressing operation, which has often resulted in erroneous operations. Known approaches to this problem include what is called force feedback function which allows an operator to feel a press input through vibration when a touch panel is operated. However, in order to provide a touch panel with such a force feedback function, a separate device for vibrating the panel is required, which has resulted in a problem in that the structure of a touch panel device becomes more complicated.

The invention has been made taking the above-described problems in the techniques according to the related art into consideration, and it is an object of the invention to provide a touch panel which has a simple configuration and which can be accurately and reliably operated.

### Means for Solving the Problem

The invention provides a touch panel including a panel constituting various types of display screens, an elongated piezoelectric element secured along each of at least two peripheral edges of the panel crossing each other, and pressed position calculating means for calculating a position in the panel which has been pressed based on output from each of the piezoelectric elements resulting from the pressing force applied to the panel.

Further, the panel includes piezoelectric element driving means for applying a voltage to the piezoelectric element to vibrate it when the pressed position in the panel is calculated by the piezoelectric element and the pressed position calculating means.

The invention also provides a touch panel including a panel constituting a display screen, an elongate piezoelectric element secured along the periphery of the panel, and press detecting means for detecting a press on the panel based on output from the piezoelectric element resulting from the pressing force applied to the panel. The panel includes a light-receiving element and a light-emitting element extending longitudinally and transversely of the same in a face-to-face relationship with each other to detect a position above the panel where light is blocked by an obstacle with the light-receiving element and light-emitting element. The touch panel further includes pressed position calculating means for outputting the position above the panel where light is blocked by the obstacle as position information when the press detecting means detects a press on the panel by the obstacle.

Further, the panel includes piezoelectric element driving means for applying a voltage to the piezoelectric element to vibrate it when the position above the panel where light is blocked is detected by the piezoelectric element and press detecting means.

### EFFECT OF THE INVENTION

The touch panel according to the invention can accurately detect and output a position on the panel which has been pressed with a simple structure employing elongated piezoelectric elements, and the panel can be easily manufactured.

Further, when the touch panel is to be provided with the force feedback function to allow an operator of the same to feel a press through vibration, the piezoelectric elements for detecting the pressed position also serve this purpose. Thus, the touch panel can be provided with the force feedback function using simple devices.

When the invention is combined with an optical touch panel, erroneous operations of the optical touch panel can be eliminated with a simple configuration. It is therefore possible to provide a touch panel which is more accurate and which can be comfortably operated.

### BRIEF DESCRIPTION OF THE DRAWINGS

FIG. 1 (a) represents a plan view of a touch panel in a mode for carrying out the invention; (b) represents a sectional view taken along a-a; and (c) represents a rear view.

FIG. 2 It is a block diagram of a pressed position detecting circuit of the touch panel in the mode for carrying out the invention.

FIG. 3 It is a graph showing output of each piezoelectric element provided when the touch panel in the mode for carrying out the invention is pressed in the middle thereof.

FIG. 4 It is a graph showing output of each piezoelectric element provided when a corner of the touch panel in the mode for carrying out the invention is pressed.

FIG. 5 (a) represents a plan view of a touch panel in another mode for carrying out the invention; and (b) represents a sectional view taken along b-b.

### DESCRIPTION OF REFERENCE NUMERALS AND SIGNS

10: touch panel
12: panel
14: frame
16: piezoelectric element
20: pressed position detecting circuit

### BEST MODES FOR CARRYING OUT THE INVENTION

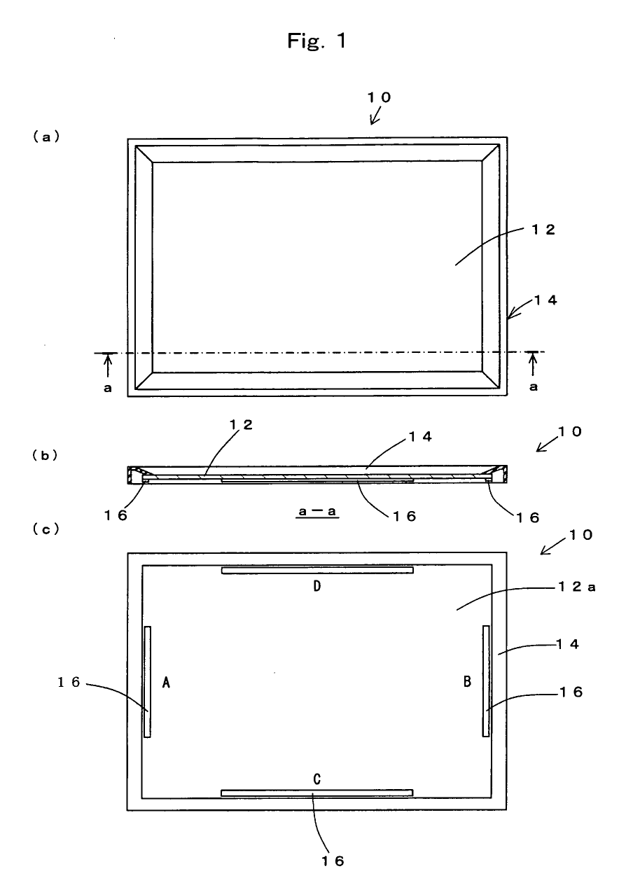

Modes for carrying out the invention will now be described based on the drawings. FIGS. 1 to 4 show a mode for carrying out the invention. A touch panel 10 in the present mode for carrying out the invention is used as an input device for car navigation apparatus, ATMs, ticket vending machines, various operation panels, and the like.

The touch panel 10 has a square panel 12 constituted by a transparent resin substrate, a glass substrate or the like and a frame 14 holding the periphery of the panel 12. Elongated piezoelectric elements 16 are secured integrally with the panel 12 to extend along four edges of a rear surface 12a of the panel. Although a piezoelectric element 16 is not required to extend the entire length of one edge of the panel 12, it preferably has a length that is about one-half or more of the length of one edge.

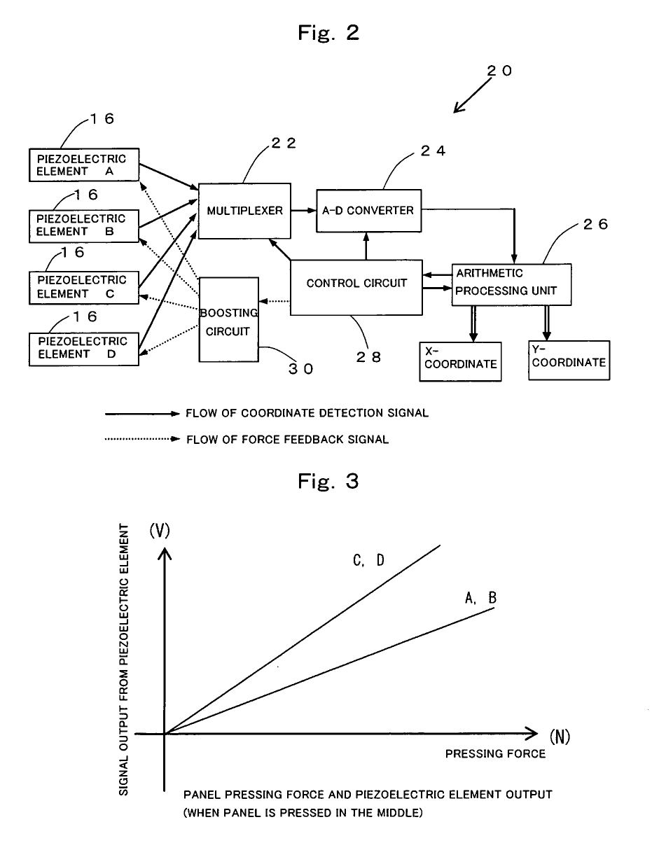

The piezoelectric elements 16 of the touch panel 10 are connected to a pressed position detecting circuit 20 which is pressed position calculating means for detecting a press on the panel 12 and finding the position of the same. In the pressed position detecting circuit 20, as shown in FIG. 2, output of each piezoelectric element 16 is connected to a multiplexer 22 and processed into signals which are output in a predetermined order. The output of the multiplexer 22 is input to an A-D converter 24 and output from the same as digital signals to a dedicated processing circuit or an arithmetic processing unit 26 constituted by a computer or the like having a processing program. As will be described later, the arithmetic processing unit 26 identifies a position on the panel 12 which has been pressed based on distortion of each piezoelectric element 16 and outputs the position using X-Y coordinates. The timing and the like of the multiplexer 22, the A-D converter 24, and the arithmetic processing unit 26 is controlled by a control circuit 28.

Each piezoelectric element 16 is connected to an output of a boosting circuit 30 which is piezoelectric element driving means for generating vibration at the piezoelectric element itself to provide the force feedback function that allow a person who pressed the panel to feel the operation. Referring to the boosting circuit 30, when the position pressed by the operator is calculated by the arithmetic processing circuit 26, the press is transmitted to the control circuit 28, and the control circuit 28 provides an output at timing immediately after the pressing operation to control the operation of the piezoelectric elements 16.

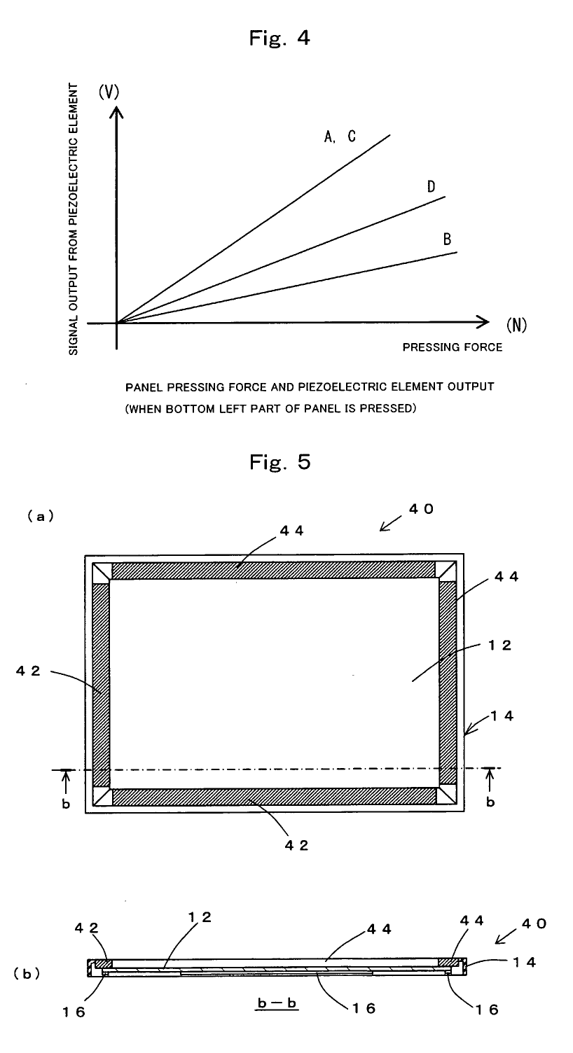

A description will now be made on a method of determining a pressed position of the touch panel 10 in the present mode for carrying out the invention. Let us assume that the piezoelectric elements 16 on the four sides are designated as piezoelectric elements A, B, C, and D, respectively. Then, for example, when a central part of the panel 12 is pressed, the piezoelectric elements C and D undergo great deflection, and the piezoelectric elements A and B undergo relatively small deflection. Therefore, the output of each piezoelectric element 16 has a tendency as shown in FIG. 3. For example, when a bottom left part of the panel 12 is pressed, the piezoelectric elements A and C located close to the pressed position undergo great deflection and provide a great signal output, and the element B furthest from the pressed position provides a small signal output. Therefore, the outputs of the piezoelectric elements 16 exhibit a tendency as shown in FIG. 4.

Thus, a position on the touch panel 10 which has been pressed can be calculated from the relative magnitudes of output signals from the piezoelectric elements 16, and the elements can therefore be used as input means of the touch panel 10.

In the case of the touch panel in the present mode for carrying out the invention, a position on the touch panel 10 which has been pressed can be calculated with the piezoelectric elements 16 and the pressed position detecting circuit 20 and can be output using X-Y coordinates. Therefore, it can be used in various ways as input means of various electronic apparatus. Further, it has a simple structure and high durability. The piezoelectric elements 16 for identifying a pressed position can be also used as piezoelectric elements for force feedback, which allows the touch panel 10 to be provided with the force feedback function using a simple configuration.

A touch panel 40 in another mode for carrying out the invention will now be described based on FIG. 5. The touch panel 40 in the present mode for carrying out the invention is a combination with an optical touch panel. A light-emitting element array 42 comprising a plurality of infrared LEDs or the like is provided in each of the transverse and longitudinal directions of a panel 12 along a frame 14 holding the periphery thereof, and light-receiving element arrays 44 comprising a plurality of photo-transistors or the like are provided on the opposite sides. Elongated piezoelectric elements 16 are secured integrally with the panel 12 on a rear surface 12a thereof so as to extend along four edges of the same.

The touch panel 40 in the present mode for carrying out the invention may include a boosting circuit 30 for a press detecting circuit 20 serving as piezoelectric element driving means for applying a voltage to the piezoelectric elements 16 to vibrate them when a position above the panel 12 where light is blocked is detected by the piezoelectric elements 16 and the press detecting circuit 20.

In the touch panel 40 in the present mode for carrying out the invention, a position above the panel 12 where light is blocked can be detected as X-Y coordinates by the two light-emitting element arrays 42 and light-receiving element arrays 44. Further, a pressing operation can be reliably detected by the piezoelectric elements 16 serving as press detecting means. A position can be more accurately detected by combining position detection using the light-emitting element arrays 42 and the light-receiving element arrays 44 and position detection using the pressed position detecting circuit 20 of the piezoelectric elements 16. It is therefore possible to form a touch panel 40 which is free from erroneous operations.

A touch panel according to the invention is not limited to the above-described modes for carrying out the invention. In the case of a combination of the same with an optical touch panel, the piezoelectric elements may be provided along at least one edge of the panel when they are to serve as press detecting means, and the elements are more preferably provided along two or more edges.

1. A touch panel characterized in that it comprises a panel constituting a display screen, an elongated piezoelectric element secured along each of at least two peripheral edges of the panel crossing each other, and pressed position calculating means for calculating a position in said panel which has been pressed based on output from each of said piezoelectric elements resulting from the pressing force applied to said panel.

2. A touch panel according to claim 1, comprising piezoelectric element driving means for applying a voltage to said piezoelectric element to vibrate it when the pressed position in said panel is calculated by said piezoelectric element and said pressed position calculating means.

3. A touch panel characterized in that it comprises a panel constituting a display screen, an elongate piezoelectric element secured along the periphery of the panel, and press detecting means for detecting a press on said panel based on output from said piezoelectric element resulting from the pressing force applied to said panel, said panel including a light-receiving element and a light-emitting element extending longitudinally and transversely of the same in a face-to-face relationship with each other to detect a position above said panel where light is blocked by an obstacle with said light-receiving element and light-emitting element, the touch panel further comprising pressed position calculating means for outputting the position above said panel where light is blocked by said obstacle as position information when said press detecting means detects a press on said panel by said obstacle.

4. A touch panel according to claim 3, comprising piezoelectric element driving means for applying a voltage to said piezoelectric element to vibrate it when the position above said panel where light is blocked is detected by said piezoelectric element and press detecting means.
